(19) United States
(12) Patent Application Publication
(10) Pub. No.: US 2025/0139478 A1
(43) Pub. Date: May 1, 2025

(54) CONTROL SIGNAL TRANSMISSION DEVICE FOR QUANTUM COMPUTER

(71) Applicant: Industrial Technology Research Institute, Hsinchu (TW)

(72) Inventors: Che-Hao Li, Hsinchu County (TW); Wei Chaun Yu, New Taipei City (TW); Po-Sheng Chang, Kaohsiung City (TW); Meng-Hsuan Chen, Taichung City (TW)

(73) Assignee: Industrial Technology Research Institute, Hsinchu (TW)

(21) Appl. No.: 18/432,057

(22) Filed: Feb. 5, 2024

(30) Foreign Application Priority Data
Oct. 31, 2023 (TW) 112141872

(51) Int. Cl. H04B 10/516; H04B 10/532; H04J 14/02; H04J 14/06

(52) U.S. Cl. CPC G06N 10/40

(57) ABSTRACT

A control signal transmission device for a quantum computer is provided. The control signal transmission device includes a laser source, a digital-to-analog converter (DAC), an electro-optic modulation circuit, an optical fiber, an optic-electro demodulation circuit and a plurality of qubits. The laser source provides a light. The DAC provides a plurality of first control signals. The electro-optic modulation circuit integrates the corresponding first control signals into the light to generate an optical signal, and provides the optical signal to the optical fiber. The optic-electro demodulation circuit converts and splits the optical signal into a plurality of second control signals. The optic-electro demodulation circuit transmits the second control signals to the corresponding qubits. The qubits are controlled by the corresponding second control signals. An ambient temperature set by the optic-electro demodulation circuit and the qubits is much lower than a preset temperature value.

### CROSS-REFERENCE TO RELATED APPLICATION

This application claims the priority benefit of Taiwan application serial no. 112141872, filed on Oct. 31, 2023. The entirety of the above-mentioned patent application is hereby incorporated by reference herein and made a part of this specification.

### TECHNICAL FIELD

The disclosure relates to a quantum computer and a control signal transmission technology, and in particular relates to a control signal transmission device for quantum computer.

### BACKGROUND

Quantum computers are devices and corresponding technologies that use quantum bits (Qubits) and the quantum logic therein to conduct general-purpose computing. The concept of quantum computing aims to control quantum states, and record and compute information through the measurement of these states. Qubits may represent two-bit states of 0 and 1 at the same time, unlike conventional computer devices that may only record one bit of information at a time. Theoretically, the computing speed of quantum computers exceeds the computing speed of current computer devices.

Currently known qubit technologies currently require extremely low temperatures to function properly, and the equipment used to control qubits typically only operates in a normal temperature environment. If it is desired to simultaneously control a large number of qubits for computation, it is necessary to correspondingly increase the control signals, which are transmitted from the normal temperature environment to the qubits located in the extremely low temperature environment through transmission lines. However, in addition to transmitting signals, the transmission line also transmits heat energy. The method of transmitting signals also consume power and generate heat. Even if an attenuator is used to reduce the power of the control signal, heat conduction cannot be avoided. Therefore, an increase in the number of transmission lines makes it difficult to maintain an extremely low temperature environment, leading to a higher likelihood of errors in qubits.

### SUMMARY

A control signal transmission device for a quantum computer is provided in the disclosure. It uses optical fiber communication combined with a variety of optical modulation technologies to transmit a large number of qubit control signals through a single transmission line, reducing the introduction of heat energy into extremely low temperature environments and facilitating the maintenance of heat insulation in extremely low temperature environments.

The control signal transmission device of the quantum computer of the disclosure includes a laser source, a digital-to-analog converter, an electro-optic modulation circuit, an optical fiber, an optic-electro demodulation circuit, and multiple qubits. The laser source provides a light. The digital-to-analog converter provides multiple first control signals. The electro-optic modulation circuit is coupled to the digital-to-analog converter and the laser source. The electro-optic modulation circuit integrates the first control signals into the light to generate an optical signal. The optical fiber is coupled to the electro-optic modulation circuit. The electro-optic modulation circuit provides the optical signal to the optical fiber. The optic-electro demodulation circuit is coupled to the optical fiber and configured to convert and split the optical signal into multiple second control signals. The qubits are coupled to the optic-electro demodulation circuit. The optic-electro demodulation circuit transmits the second control signals to the corresponding qubits. The qubits are controlled by the corresponding second control signals. An ambient temperature set by the optic-electro demodulation circuit and the qubits is lower than a preset temperature value.

Based on the above, in the embodiment of the disclosure, the quantum computers and the control signal transmission technology integrate a large number of control signals into an optical carrier serving as a signal carrier by utilizing a variety of optical modulation techniques, such as frequency division multiplexing (FDM), wavelength division multiplexing (WDM), polarization multiplexing (Pol-Mux), and a combination of these multiplexing techniques, and use a single optical fiber as the transmission line. This achieves a quantum computer control architecture that transmits signals controlling a large number of qubits. The aforementioned architecture may reduce the introduction of heat energy into the extremely low temperature environment and facilitate the maintenance of heat insulation in the extremely low temperature environment.

### BRIEF DESCRIPTION OF THE DRAWINGS

FIG. 1 is a block schematic diagram of a control signal transmission device for a quantum computer according to the first embodiment of the disclosure.

FIG. 2A to FIG. 2B are the circuit diagram and corresponding signal schematic diagrams of a control signal transmission device 100-1 for a quantum computer according to the second embodiment of the disclosure.

FIG. 3A to FIG. 3B are the circuit diagram and corresponding signal schematic diagrams of a control signal transmission device 100-2 for a quantum computer according to the third embodiment of the disclosure.

FIG. 4A to FIG. 4B are the circuit diagram and corresponding signal schematic diagrams of a control signal transmission device 100-3 for a quantum computer according to the fourth embodiment of the disclosure.

FIG. 5A to FIG. 5B are the circuit diagram and corresponding signal schematic diagrams of a control signal transmission device 100-4 for a quantum computer according to the fifth embodiment of the disclosure.

FIG. 6A to FIG. 6B are the circuit diagram and corresponding signal schematic diagrams of a control signal transmission device 100-5 for a quantum computer according to the sixth embodiment of the disclosure.

FIG. 7A to FIG. 7D are the circuit diagrams and corresponding signal schematic diagrams of a control signal transmission device 100-6 for a quantum computer according to the seventh embodiment of the disclosure.

FIG. 8A to FIG. 8F are the circuit diagrams and corresponding signal schematic diagrams of a control signal transmission device 100-7 for a quantum computer according to the eighth embodiment of the disclosure.

### DETAILED DESCRIPTION OF DISCLOSED EMBODIMENTS

In order to maintain the extremely low temperature environment of the qubits and the insulation to prevent from damaging this extremely low temperature environment, embodiments of the disclosure adopt optical fiber communication to transmit control signals from a normal temperature environment to the extremely low temperature environment where the qubits are located. Additionally, a large number of control signals are integrated into the optical carrier serving as the signal carrier in a multiplexed manner by using a variety of optical modulation techniques. The advantage of optical fiber communication is that almost no heat is carried when transmitting data, and optical signals have nearly infinite bandwidth, which is very suitable for quantum computer applications. When this optical carrier is transmitted to an extremely low temperature environment, the corresponding demodulation device receives and restores these control signals, and then provide these control signals to their corresponding qubits, thereby achieving a signal transmission architecture for quantum computers that uses a single optical fiber to transmit a large number of control signals to control qubits. A variety of control signal transmission devices and their circuit architectures used in quantum computers are proposed below as embodiments of the disclosure. Those who apply this embodiment may use the following embodiments as a basis to extend to other implementations of the disclosure according to their requirements.

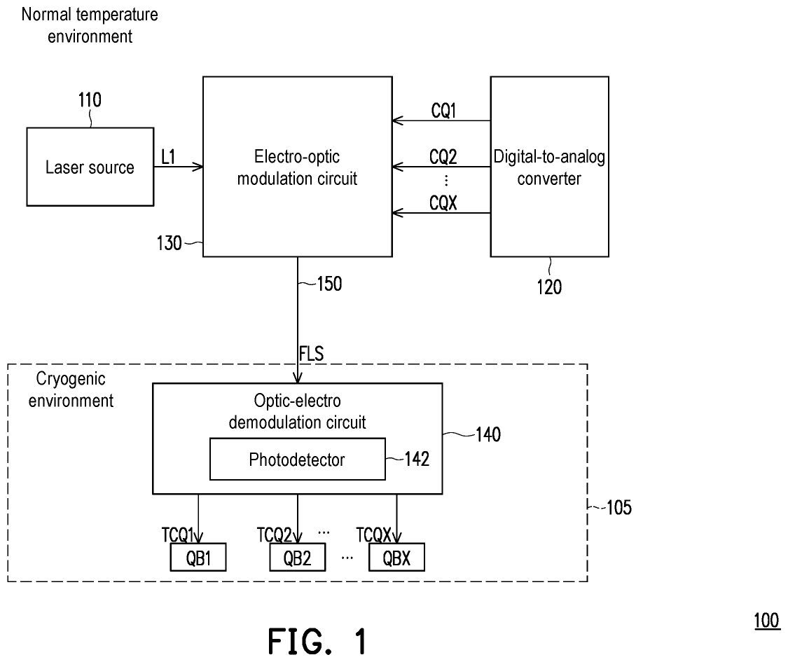

FIG. 1 is a block schematic diagram of a control signal transmission device for a quantum computer according to the first embodiment of the disclosure. In FIG. 1, the control signal transmission device 100 for a quantum computer includes a laser source 110, a digital-to-analog converter 120, an electro-optic modulation circuit 130, an optical fiber 150, an optic-electro demodulation circuit 140, and multiple qubits QB1 to QBX, where X is a positive integer.

The laser source 110 provides a light L1. The digital-to-analog converter 120 provides multiple first control signals CQ1 to CQX. The electro-optic modulation circuit 130 is coupled to the digital-to-analog converter 120 and the laser source 110. The electro-optic modulation circuit 130 integrates the first control signals CQ1 to CQX into the light L1 to generate the optical signal FLS. The optical fiber 150 is coupled to the electro-optic modulation circuit 130 located in a normal temperature environment and the optic-electro demodulation circuit 140 located in a cryogenic environment 105. The optic-electro demodulation circuit 140 converts and splits the optical signal FLS into multiple second control signals TCQ1 to TCQX. The optic-electro demodulation circuit 140 transmits the second control signals TCQ1 to TCQX to the corresponding qubits QB1 to QBX. The qubits QB1 to QBX are respectively controlled by the corresponding second control signals TCQ1 to TCQX. The temperature of the cryogenic environment 105 set by the optic-electro demodulation circuit 140 and the qubits QB1 to QBX is much lower than a preset temperature value. The preset temperature value is mainly set according to the extremely low temperature environment required for the quantum bits QB1 to QBX. For example, the aforementioned preset temperature value may be 1K (−272.15° C.), and the temperature of the aforementioned cryogenic environment 105 is much lower than 1K (−272.15° C.). Those who apply this embodiment may correspondingly set and adjust the preset temperature value according to the temperature used to set the qubit in the current technology. The preset temperature value is not limited only to the foregoing examples.

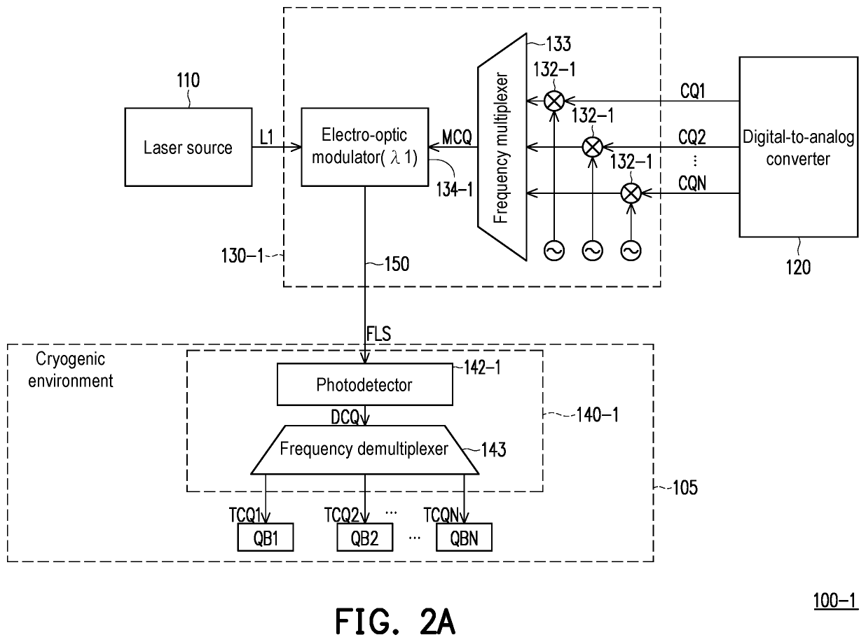

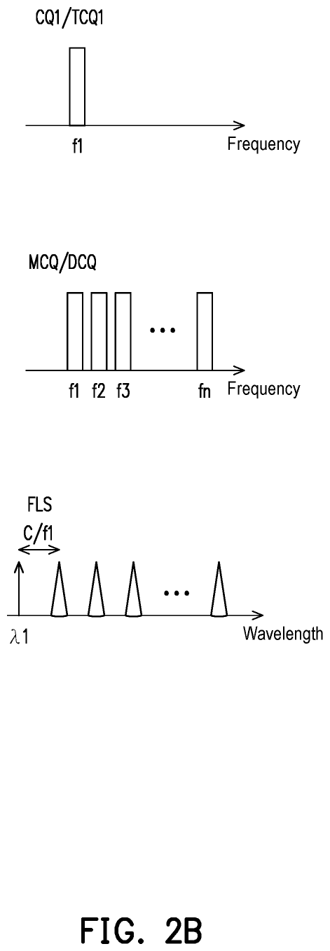

In this embodiment, optical fiber communication is used to transmit control signals for controlling qubits QB1 to QBX, and a large number of control signals (e.g., the first control signals CQ1 to CQX) are integrated into the optical carrier serving as the signal carrier. The optical modulation technology for integrating control signals at least includes frequency division multiplexing (FDM) technology, wavelength division multiplexing (WDM) technology, polarization multiplexing (Pol-Mux) technology, and any combination of these multiplexing technologies. This allows a large number of control signals to be carried on the optical signal FLS on the same optical fiber 150, and the optical fiber 150 is used such that equipment in a normal temperature environment (e.g., electro-optic modulation circuit 130) to communicate with equipment in a cryogenic environment 105 (e.g., optic-electro demodulation circuit 140). Since these optical modulation technologies and multiplexing technologies mainly change in the electro-optic modulation circuit 130 and the optic-electro demodulation circuit 140 in FIG. 1, the embodiments of the disclosure mainly illustrate the circuit structure and operation mode of the electro-optic modulation circuit and the optic-electro demodulation circuit in different embodiments from FIG. 2A to FIG. 8F.

FIG. 2A to FIG. 2B are the circuit diagram and corresponding signal schematic diagrams of a control signal transmission device 100-1 for a quantum computer according to the second embodiment of the disclosure. The control signal transmission device 100-1 in FIG. 2A integrates N control signals CQ1 to CON into the optical signal FLS of the optical fiber 150 by using frequency division multiplexing (FDM) technology, where N is a positive integer.

The electro-optic modulation circuit 130-1 in FIG. 2A includes N mixers 132-1, a frequency multiplexer 133 and an electro-optic modulator 134-1. The N mixers 132-1 are coupled to the digital-to-analog converter 120 to receive corresponding first control signals CQ1 to CON, and adjust the corresponding first control signals CQ1 to CON to different frequencies to generate N mixed signals. The bandwidth is mainly limited by the frequencies adjusted by the N mixers 132-1. The frequency multiplexer 133 is coupled to the N mixers 132-1. The frequency multiplexer 133 integrates these mixed signals into an integrated signal MCQ according to different frequencies in the aforementioned signals. The electro-optic modulator 134-1 is coupled to the frequency multiplexer 133 and the laser source 110. The electro-optic modulator 134-1 integrates the integrated signal MCQ into the light L1 provided by the laser source 110 to generate the optical signal FLS. In this embodiment, the wavelength of the optical signal FLS provided in the electro-optic modulator 134-1 is expressed as wavelength λ1.

The optic-electro demodulation circuit 140-1 in FIG. 2A includes a photodetector 142-1 and a frequency demultiplexer 143. The photodetector 142-1 is coupled to the optical fiber 150 and converts the optical signal FLS into an electrical signal DCQ. The frequency demultiplexer 143 is coupled to the photodetector 142-1. The frequency demultiplexer 143 splits the electrical signal DCQ into second control signals TCQ1 to TCQN according to the aforementioned different frequencies adjusted by each of the N mixers 132-1 on the N mixed signals. The number of second control signals TCQ1 to TCQN is N.

FIG. 2B presents the modulation conditions of each signal in this embodiment with specific signals. The first control signal CQ1 and the second control signal TCQ1 are both electrical signals of frequency f1. The integrated signal MCQ and the electrical signal DCQ are signals obtained by integrating the aforementioned control signals CQ1 to CON and TCQ1 to TCQN, so their electrical signal waveforms have multiple frequencies f1 to fn. The optical signal FLS modulated by the electro-optic modulator 134-1 is shown in FIG. 2B. The optical signal FLS generates corresponding waveforms at corresponding multiple wavelengths due to a certain distance (the value of light speed C divided by frequency f1) away from the wavelength 21.

It is known from FIG. 2A and FIG. 2B that the control signal transmission device 100-1 in FIG. 2A integrates multiple control signals into the optical carrier by using the frequency multiplexer 133 and frequency division multiplexing (FDM) technology, and splits the optical signal FLS by using the frequency demultiplexer 143 to obtain a large number of control signals for controlling the qubits QB1 to QBN in the cryogenic environment 105.

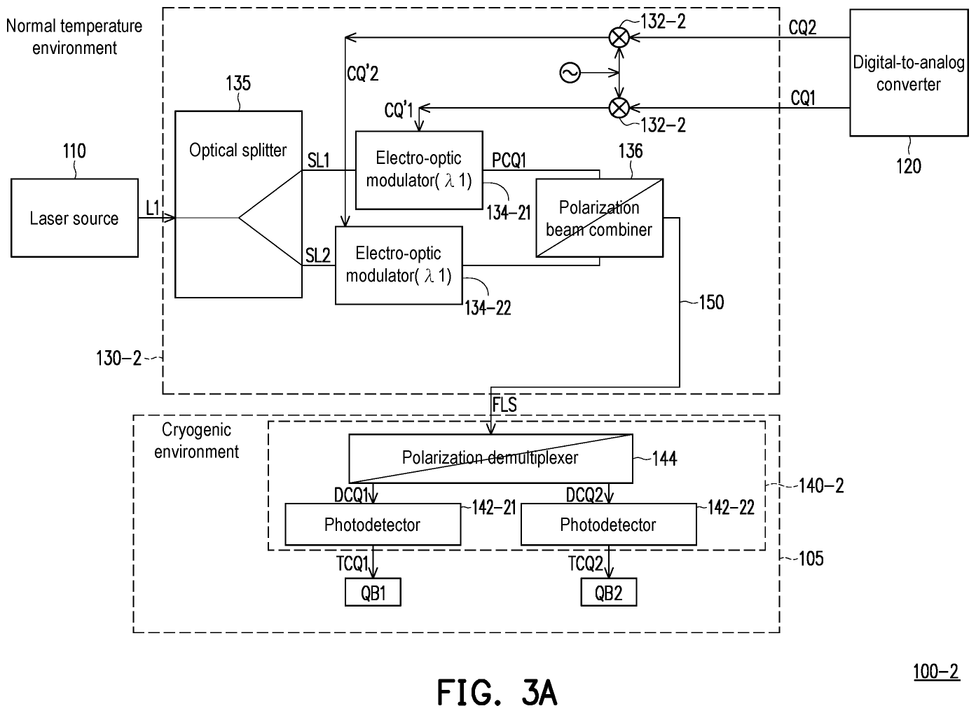

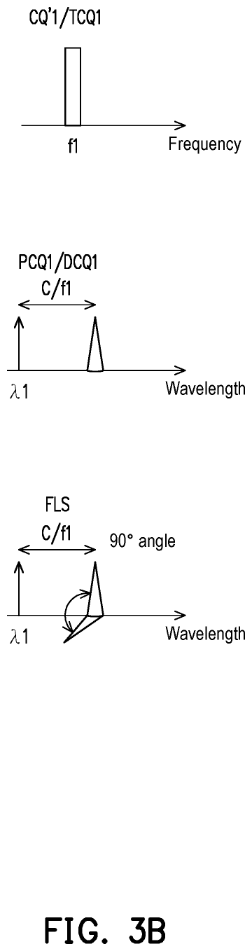

FIG. 3A to FIG. 3B are the circuit diagram and corresponding signal schematic diagrams of a control signal transmission device 100-2 for a quantum computer according to the third embodiment of the disclosure. The control signal transmission device 100-2 in FIG. 3A integrates P control signals CQ1 to CQP into the optical signal FLS of the optical fiber 150 by using polarization multiplexing (Pol-Mux) technology, where P is a positive integer. In optical fiber transmission technology, lights may be differentiated because the polarity of the two lights differs by 90 degrees. In other words, lights may be differentiated into two different types of light with polarities differing by 90 degrees, so the number 2 is used as P in this embodiment.

The electro-optic modulation circuit 130-2 in FIG. 3A includes two mixers 132-2, an optical splitter 135, two electro-optic modulators 134-21 and 134-22, and a polarization beam combiner 136. The two mixers 132-2 are coupled to the digital-to-analog converter 120 to receive the corresponding first control signals CQ1 and CQ2, and increase the frequencies of the corresponding first control signals CQ1 and CQ2 to generate two upconverted signals CQ′ 1 and CQ′2. The two mixers 132-2 boost the first control signals CQ1 and CQ2 to the same frequency (e.g., frequency f1 in FIG. 3B).

The optical splitter 135 is coupled to the laser source 110. The optical splitter 135 splits the light L1 into two sub-lights SL1 and SL2. The two electro-optic modulators 134-21 and 134-22 are respectively coupled to the optical splitter 135 and the mixers 132-2. The two electro-optic modulators 134-21 and 134-22 receive the corresponding upconverted signals CQ′1 and CQ′2 from the corresponding mixers 132-2, and integrate the corresponding upconverted signals CQ′1 and CQ′2 into the sub-lights SL1 and SL2 to form two modulated optical signals, one of which is represented as PCQ1. The electro-optic modulators 134-21 and 134-22 have the same wavelength λ1, and each electro-optic modulator 134-21 and 134-22 integrates the upconverted signals CQG1 and CQG2 into the optical signal based on its corresponding wavelength 21. The polarization beam combiner 136 is coupled to the electro-optic modulators 134-21 and 134-22. The polarization beam combiner 136 receives and integrates the modulated optical signal to generate the optical signal FLS. In this embodiment, the two modulated optical signals (one of which is the modulated optical signal PCQ1) generated by the electro-optic modulators 134-21 and 134-22 have the same polarization direction. After the two modulated optical signals enter the polarization beam combiner 136, the polarization beam combiner 136 combines the two modulated optical signals according to different polarization directions to generate an optical signal FLS.

The optic-electro demodulation circuit 140-2 of FIG. 3A includes a polarization demultiplexer 144 and photodetectors 142-21 and 142-22. The polarization demultiplexer 144 is coupled to the optical fiber 150. The polarization demultiplexer 144 converts the optical signal FLS into two differentiated optical signals DCQ1 and DCQ2 according to the aforementioned different polarization directions. The two photodetectors 142-21 and 142-22 are respectively coupled to the polarization demultiplexer 144. The two photodetectors 142-21 and 142-22 respectively generate second control signals TCQ1 and TCQ2 according to the corresponding differentiated optical signals DCQ1 and DCQ2.

FIG. 3B presents the modulation conditions of each signal in this embodiment with specific signals. Both the upconverted signal CQ′1 and the differentiated optical signal DCQ1 are a certain distance (the value of light speed C divided by frequency f1) away from the wavelength λ1, and generate optical signals with corresponding waveforms at the corresponding wavelength. The optical signal FLS modulated by the electro-optic modulators 134-21 and 134-22 is shown in FIG. 3B. The polarity of the optical signal FLS generates corresponding waveforms at corresponding multiple wavelengths due to a certain distance (the value of light speed C divided by frequency f1) away from the wavelength λ1, and the polarity between the two waveforms shows a 90-degree angle difference.

It is known from FIG. 3A and FIG. 3B that the control signal transmission device 100-2 in FIG. 3A integrates the two control signals into the optical carrier by using the optical splitter 135, the polarization beam combiner 136, and the polarization multiplexing (Pol-Mux) technology, and splits the optical signal FLS by using the polarization demultiplexer 144 to obtain two second control signals TCQ1 and TCQ2 for controlling the qubits QB1 to QBN in the cryogenic environment 105.

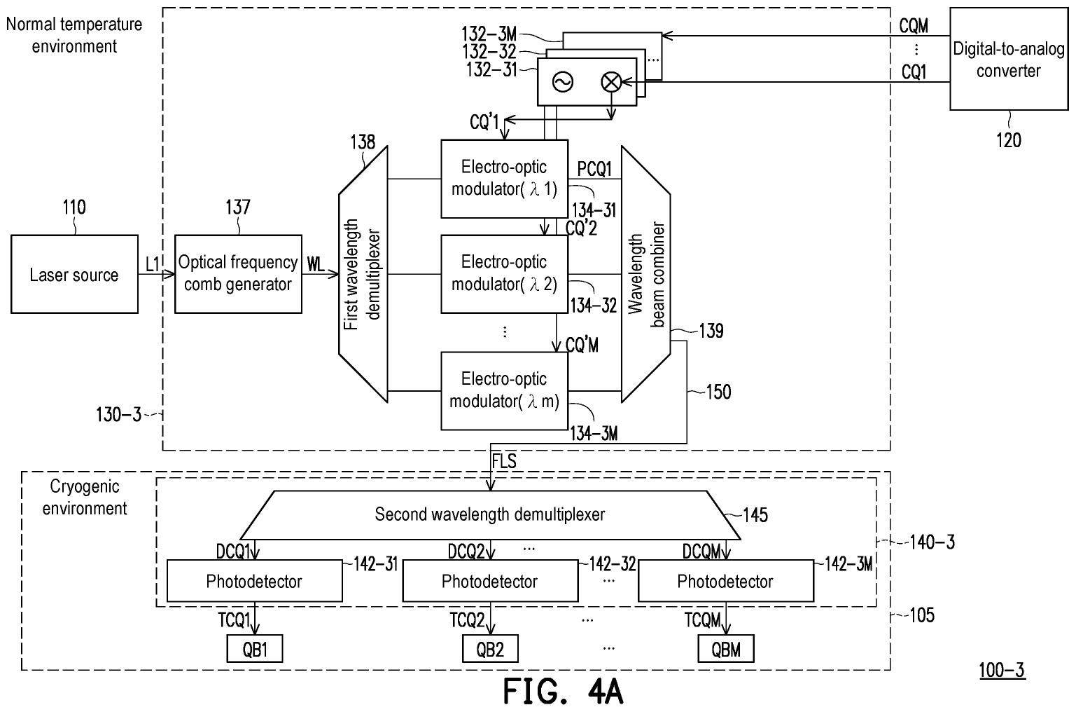

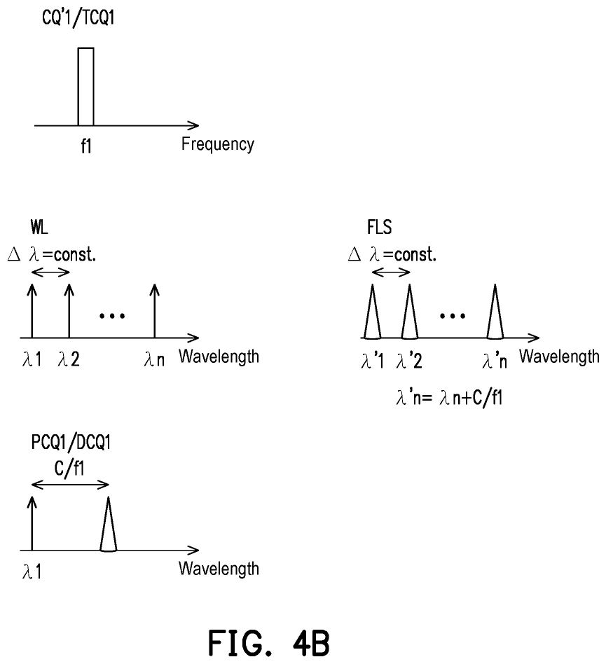

FIG. 4A to FIG. 4B are the circuit diagram and corresponding signal schematic diagrams of a control signal transmission device 100-3 for a quantum computer according to the fourth embodiment of the disclosure. The control signal transmission device 100-3 in FIG. 4A integrates M control signals CQ1 to CQM into the optical signal FLS of the optical fiber 150 by using wavelength division multiplexing (WDM) technology, where M is a positive integer.

The electro-optic modulation circuit 130-3 in FIG. 4A includes M mixers 132-31 to 132-3M, an optical frequency comb generator 137, a first wavelength demultiplexer 138, M electro-optic modulators 134-31 to 134-3M, and a wavelength beam combiner 139. The M mixers 132-31 to 132-3M are coupled to the digital-to-analog converter 120 to receive the corresponding first control signals CQ1 to COM, and increase the frequencies of the corresponding first control signals CQ1 to CQM to generate M upconverted signals (herein, the upconverted signals CQ′1, CQ′2, CQ′M are used as examples). The optical frequency comb generator 137 is coupled to the laser source 110. The optical frequency comb generator 137 generates multi-wavelength light WL from the light L1 according to different wavelengths. The first wavelength demultiplexer 138 is coupled to the optical frequency comb generator 137. The first wavelength demultiplexer 138 differentiates the multi-wavelength light WL into M specific wavelength lights according to the aforementioned different wavelengths.

The M electro-optic modulators 134-31 to 134-3M are coupled to the first wavelength demultiplexer 138 and the mixers 132-31 to 132-3M. The M electro-optic modulators 134-31 to 134-3M respectively receive corresponding upconverted signals from corresponding mixers 132-31 to 132-3M, and integrate the corresponding upconverted signals CQ′1, CQ′2 . . . . CQ′M into the specific wavelength light corresponding to the aforementioned different wavelengths to generate M first wavelength divided optical signals (herein, the first wavelength divided optical signal PCQ1 is taken as an example). The electro-optic modulators 134-31 to 134-3M in FIG. 4A each have different wavelengths λ1, λ2 . . . λn, and each electro-optic modulator 134-31 to 134-3M integrates the upconverted signals CQ′1, CQ′2 . . . . CQ′M into the optical signal based on its corresponding wavelength λ1, λ2 . . . λn. The wavelength beam combiner 139 is coupled to the electro-optic modulators 134-31 to 134-3M. The wavelength beam combiner 139 receives and integrates the first wavelength divided optical signal to generate an optical signal FLS.

The optic-electro demodulation circuit 140-3 of FIG. 4A includes a second wavelength demultiplexer 145 and M photodetectors 142-31 to 142-3M. The second wavelength demultiplexer 145 is coupled to the optical fiber 150 and converts the optical signal FLS into M second wavelength divided optical signals DCQ1 to DCQM according to different wavelengths adopted by the first wavelength demultiplexer 138. The M photodetectors 142-31 to 142-3M are coupled to the second wavelength demultiplexer 145. The M photodetectors 142-31 to 142-3M generate second control signals TCQ1 to TCQM according to the second wavelength divided optical signals DCQ1 to DCQM.

FIG. 4B presents the modulation conditions of each signal in this embodiment with specific signals. The upconverted signal CQ′1 and the second control signal TCQ1 are both electrical signals of frequency f1. Multi-wavelength light WL, as shown in FIG. 4B, is an optical signal showing different waveforms at multiple different wavelengths λ1, λ2 . . . λn. The wavelength spacing Δλ between these wavelengths λ1, λ2 . . . λn is a constant, that is, the spacing Δλ between adjacent wavelengths is the same. Both the first wavelength divided optical signal PCQ1 and the second wavelength divided optical signal DCQ1 are a certain distance (the value of light speed C divided by frequency f1) away from the wavelength λ1, and generate optical signals with corresponding waveforms at the corresponding wavelength. The optical signal FLS modulated by the electro-optic modulation circuit 130-3 is shown in FIG. 4B. The optical signal FLS has multiple wavelengths λ′1, λ′2 . . . λ′n, and at these wavelengths λ′1, λ′2 . . . λ′n, optical signals corresponding to the waveforms are generated. These wavelengths λ′1, λ′2 . . . λ′n are the values corresponding to the wavelengths λ1, λ2 . . . λn plus a distance (the value of light speed C divided by frequency f1).

It is known from FIG. 4A and FIG. 4B that the control signal transmission device 100-3 in FIG. 4A integrates multiple control signals into the optical carrier by using the optical frequency comb generator 137, the first wavelength demultiplexer 138, the wavelength beam combiner 139 and the wavelength division multiplexing (WDM) technology, and splits the optical signal FLS by using the second wavelength demultiplexer 145 to obtain a large number of control signals for controlling the qubits QB1 to QBM in the cryogenic environment 105.

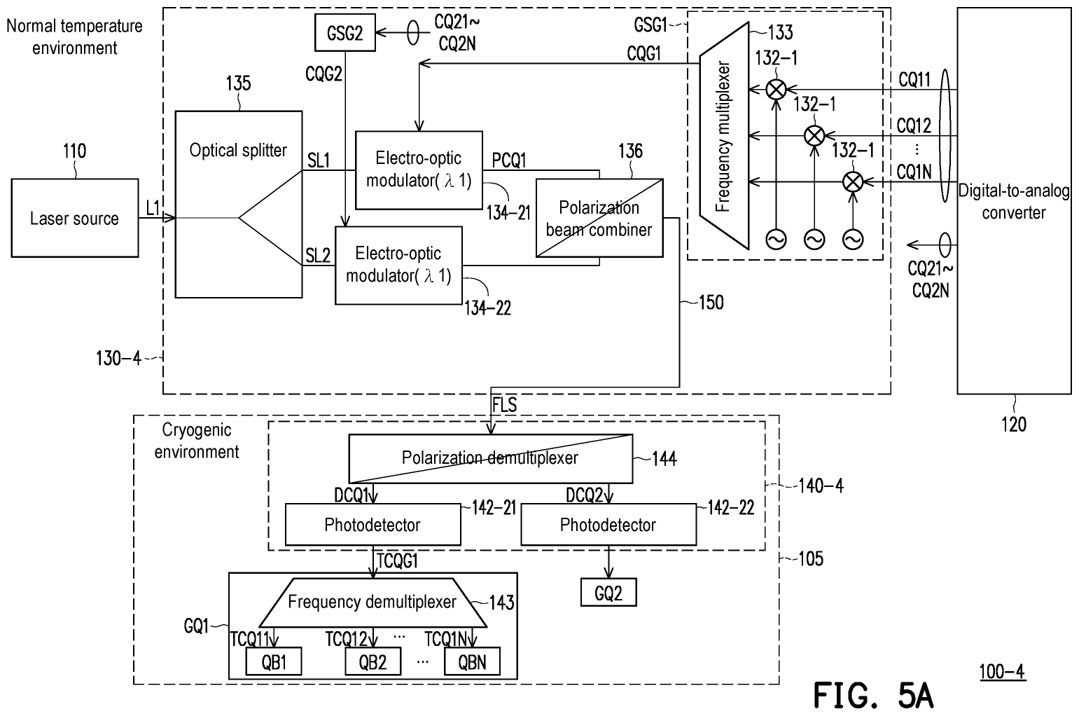

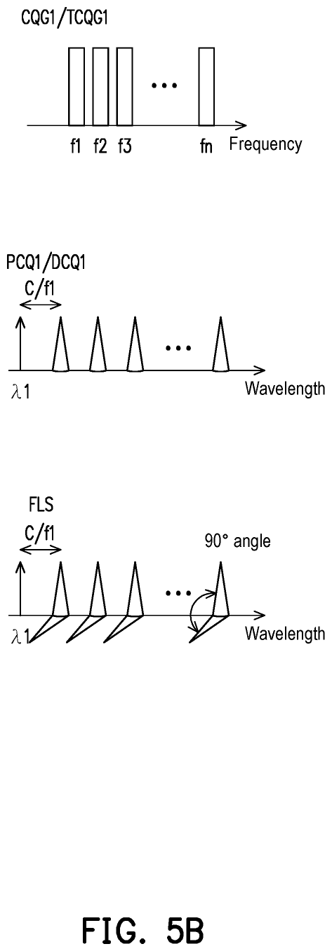

FIG. 5A to FIG. 5B are the circuit diagram and corresponding signal schematic diagrams of a control signal transmission device 100-4 for a quantum computer according to the fifth embodiment of the disclosure. The control signal transmission device 100-4 in FIG. 5A integrates N times P (P is 2) control signals CQ11 to CQ1N and CQ21 to CQ2N into the optical signal FLS of the optical fiber 150 by using frequency division multiplexing (FDM) technology combined with polarization multiplexing (Pol-Mux) technology, where N and P are both positive integers. As mentioned above, limited by the number of polarizations of light, P is set to 2 in this embodiment. In other words, part of the circuit of the control signal transmission device 100-4 is similar to the aforementioned circuits of FIG. 2A and FIG. 3A, and some of the components herein use the same reference number.

The electro-optic modulation circuit 130-4 in FIG. 5A includes two frequency division modulation circuits GSG1 and GSG2, an optical splitter 135, two electro-optic modulators 134-21 to 134-22, and a polarization beam combiner 136. Each frequency division modulation circuit GSG1/GSG2 receives N first control signals CQ11 to CQ1N/CQ21 to CQ2N to generate one of two frequency divided signals, such as the frequency divided signal CQG1/CQG2. The optical splitter 135 splits the light L1 into two sub-lights SL1 and SL2. The two electro-optic modulators 134-21 and 134-22 receive the corresponding frequency divided signals CQG1 and CQG2 from the corresponding frequency division modulation circuits GSG1 and GSG2, and integrate the corresponding frequency divided signals CQG1 and CQG2 into the sub-lights SL1 and SL2 to generate two modulated optical signals with different polarization directions (herein, the modulated optical signal PCQ1 is used as an example). The electro-optic modulators 134-21 and 134-22 have the same wavelength λ1, and each electro-optic modulator 134-21 and 134-22 integrates the upconverted signals CQG1 and CQG2 into the optical signal based on its corresponding wavelength 21. The polarization beam combiner 136 receives and integrates the modulated optical signal to generate the optical signal FLS.

Each frequency division modulation circuit GSG1/GSG2 in FIG. 5A includes N mixers 132-1 and a frequency multiplexer 133, and the functions of these components are the same as those of the corresponding components in FIG. 2A. The frequency division modulation circuit GSG1/GSG2 receives the corresponding first control signals CQ11 to CQ1N and CQ21 to CQ2N, adjusts the corresponding first control signal to different frequencies to generate N mixed signals, and integrates these mixed signals into one of the two frequency division signals CQG1 and CQG2.

The optic-electro demodulation circuit 140-4 in FIG. 5A includes a polarization demultiplexer 144, two photodetectors 142-21 and 142-22, and two frequency demultiplexers (frequency demultiplexer 143 is used as an example in FIG. 5A). The polarization demultiplexer 144 is coupled to the optical fiber 150 and converts the optical signal FLS into two differentiated optical signals DCQ1 and DCQ2 according to different polarization directions. The two photodetectors 142-21 and 142-22 respectively generate two electrical signals (herein, the electrical signal TCQG1 is taken as an example) according to the corresponding differentiated optical signals DCQ1 and DCQ2. The frequency demultiplexer 143 located in the circuit GQ1 splits one of the corresponding P electrical signals into N second control signals TCQ11 to TCQ1N according to different frequencies. On the other hand, the circuit structure of circuit GQ2 is the same as that of circuit GQ1.

FIG. 5B presents the modulation conditions of each signal in this embodiment with specific signals. The upconverted signal CQG1 and the electrical signal TCQG1 are signals that integrate multiple control signals with different frequencies f1 to fn, so their electrical signal waveforms have multiple frequencies f1 to fn. Both the modulated optical signal PCQ1 and the differentiated optical signal DCQ1 generate corresponding waveforms at corresponding multiple wavelengths due to a certain distance (the value of light speed C divided by frequency f1) away from the wavelength λ1. The optical signal FLS is based on the aforementioned modulated optical signal PCQ1 and further includes two waveforms of different polarities. The polarities between the two waveforms show a 90-degree angle difference.

It is known from FIG. 5A and FIG. 5B that the control signal transmission device 100-4 in FIG. 5A integrates a large number of control signals into the optical carrier by using the wavelength division multiplexing (WDM) and polarization multiplexing (Pol-Mux) technologies, and thereby obtains control signals for controlling a large number of qubits in a cryogenic environment 105.

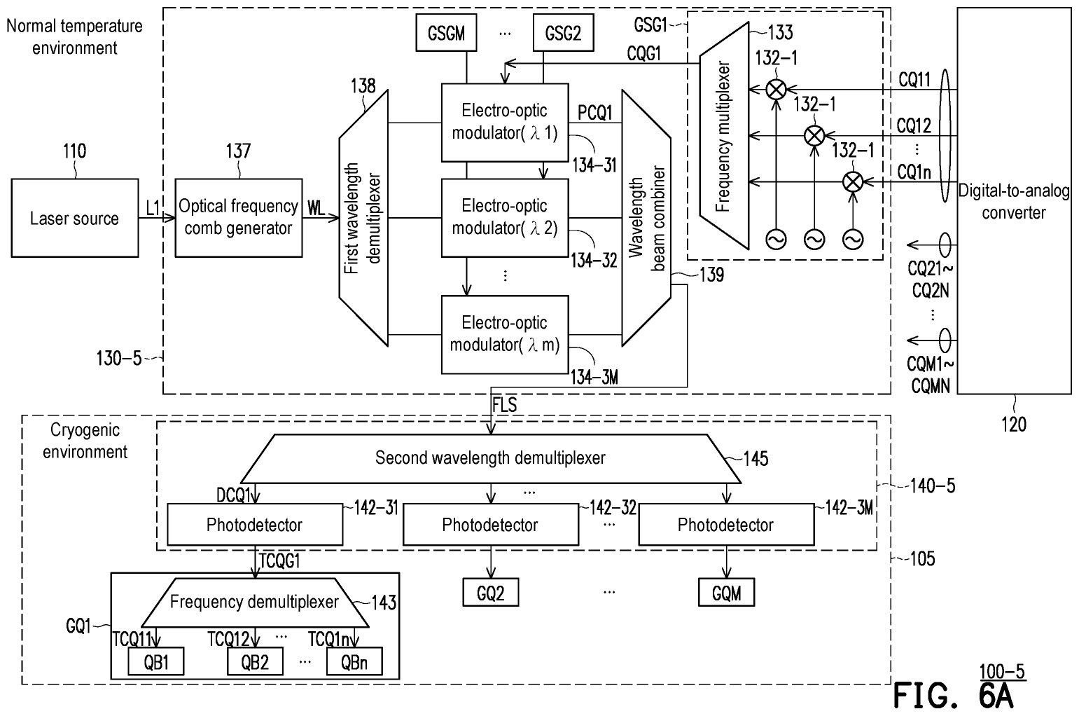

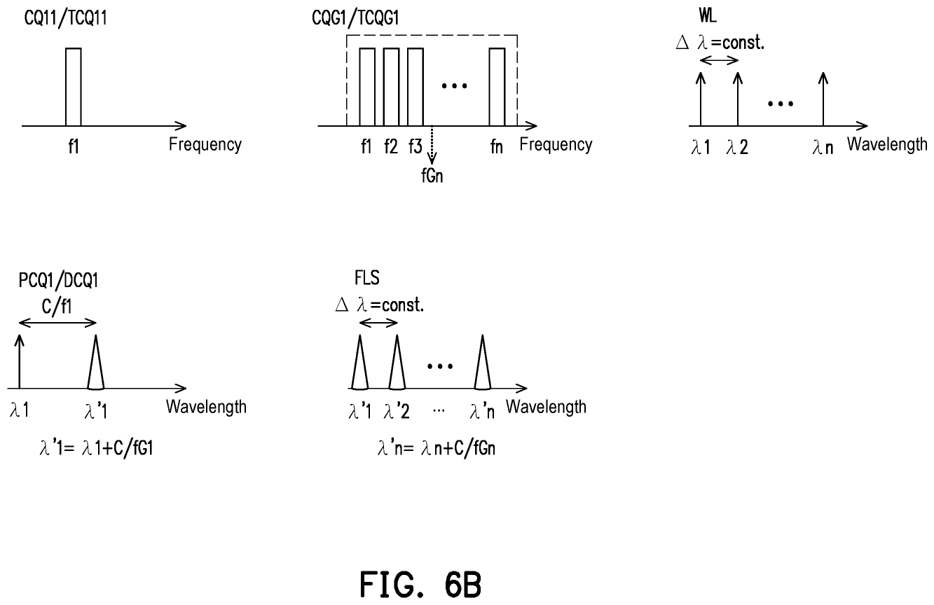

FIG. 6A to FIG. 6B are the circuit diagram and corresponding signal schematic diagrams of a control signal transmission device 100-5 for a quantum computer according to the sixth embodiment of the disclosure. The control signal transmission device 100-5 in FIG. 6A integrates N times M control signals CQ11 to CQ1N, CQ21 to CQ2N, . . . , CQM1 to CQMN into the optical signal FLS of the optical fiber 150 by using frequency division multiplexing (FDM) technology combined with wavelength division multiplexing (WDM) technology, where N and M are both positive integers. Part of the circuit of the control signal transmission device 100-5 is similar to the aforementioned circuits of FIG. 2A and FIG. 4A, and some of the components herein use the same reference number.

The electro-optic modulation circuit 130-5 of FIG. 6A includes M frequency division modulation circuits GSG1 to GSGM, an optical frequency comb generator 137, a first wavelength demultiplexer 138, M electro-optic modulators 134-31 to 134-3M, and a wavelength beam combiner 139. Each frequency division modulation circuit GSG1 to GSGM receives N first control signals CQ11 to CQMN to generate one of M frequency divided signals (herein, the frequency divided signal CQG1 is taken as an example). The optical frequency comb generator 137 generates multi-wavelength light WL from the light L1 according to different wavelengths. The first wavelength demultiplexer 138 differentiates the multi-wavelength light WL into M specific wavelength lights according to the aforementioned different wavelengths. The M electro-optic modulators 134-31 to 134-3M respectively receive corresponding frequency divided signals from the frequency division modulation circuits GSG1 to GSGM, and integrate the corresponding frequency divided signals into M specific wavelength lights corresponding to different wavelengths to generate M first wavelength divided optical signals (herein, the first wavelength divided optical signal PCQ1 is taken as an example). The wavelength beam combiner 139 receives and integrates the first wavelength divided optical signal to generate an optical signal FLS. The frequency division modulation circuits GSG1 to GSGM are the same as the frequency division modulation circuit GSG1 in FIG. 6A, and they all include N mixers 132-1 and the frequency multiplexer 133.

The optic-electro demodulation circuit 140-5 in FIG. 6A includes a second wavelength demultiplexer 145, M photodetectors 142-31 to 142-3M, and M frequency demultiplexers (e.g., the frequency demultiplexer 143 in the circuit GQ1). The second wavelength demultiplexer 145 converts the optical signal FLS into M second differentiated optical signals according to different wavelengths (herein, the second differentiated optical signal DCQ1 is taken as an example). The M photodetectors 142-31 to 142-3M respectively generate M electrical signals (herein, the electrical signal TCQG1 is taken as an example) according to the corresponding second differentiated optical signals. The frequency demultiplexer 143 splits one of the corresponding M electrical signals (e.g., the electrical signal TCQG1) into N second control signals according to different frequencies, such as the second control signals TCQ11 to TCQ1N.

FIG. 6B presents the modulation conditions of each signal in this embodiment with specific signals. The first control signal CQ11 and the second control signal TCQ11 are electrical signals with frequency f1. The frequency divided signal CQG1 and the electrical signal TCQG1 are electrical signals that integrate multiple control signals with different frequencies f1 to fn, so their electrical signal waveforms have multiple frequencies f1 to fn. The average frequency of the frequency divided signal CQG1 and the electrical signal TCQG1 is fGn. Multi-wavelength light WL shown in FIG. 6B is an optical signal showing different waveforms at multiple different wavelengths λ1, λ2 . . . λn. The wavelength spacing Δλ between these wavelengths λ1, λ2 . . . λn is a constant, that is, the spacing Δλ between adjacent wavelengths is the same. Both the first wavelength divided optical signal PCQ1 and the second differentiated optical signal DCQ1 are a certain distance (the value of light speed C divided by frequency f1) away from the wavelength λ1, and generate optical signals with corresponding waveforms at the wavelength λ′1. The optical signal FLS has multiple wavelengths λ′1, λ′2 . . . λ′n, and at these wavelengths λ′1, λ′2 . . . λ′n, optical signals corresponding to the waveforms are generated. These wavelengths λ′1, λ′2 . . . λ′n are the values corresponding to the wavelengths λ1, λ2 . . . λn plus a distance (the value of light speed C divided by frequency fGn).

It is known from FIG. 6A and FIG. 6B that the control signal transmission device 100-5 in FIG. 6A integrates a large number of control signals into the optical carrier by using the frequency division multiplexing (FDM) and wavelength division multiplexing (WDM) technologies, and thereby obtains control signals for controlling a large number of qubits in a cryogenic environment 105.

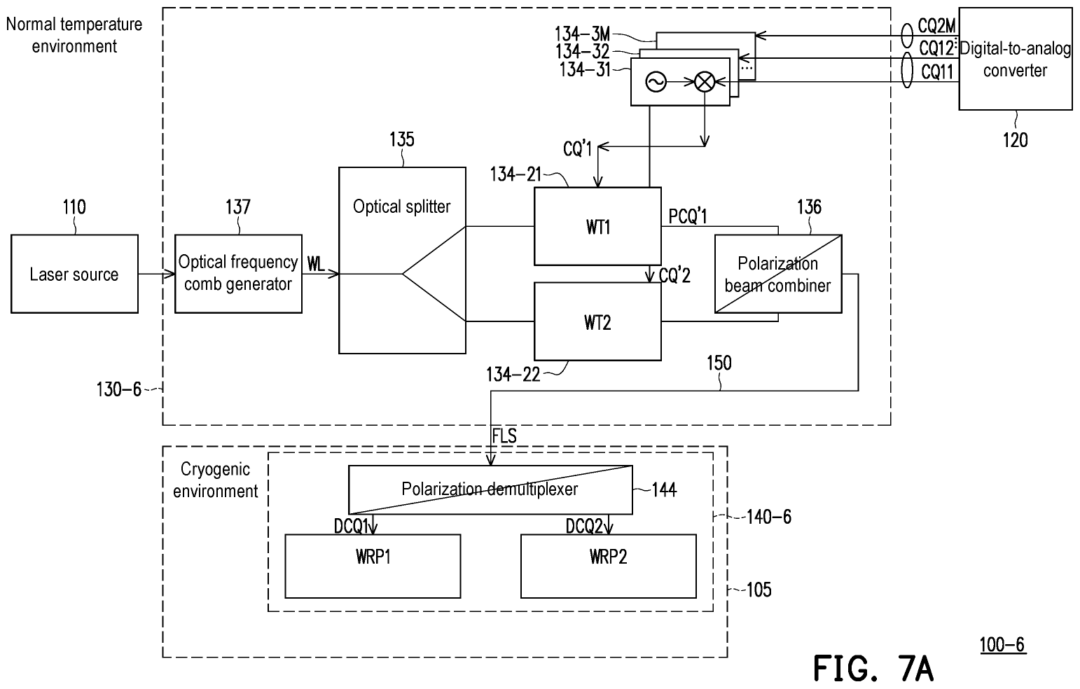

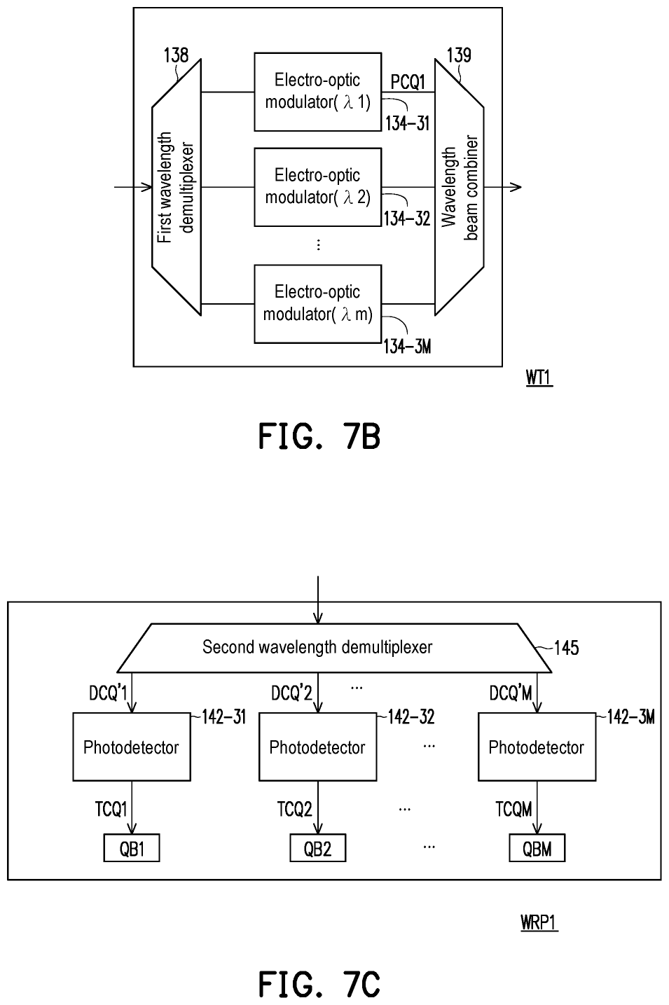

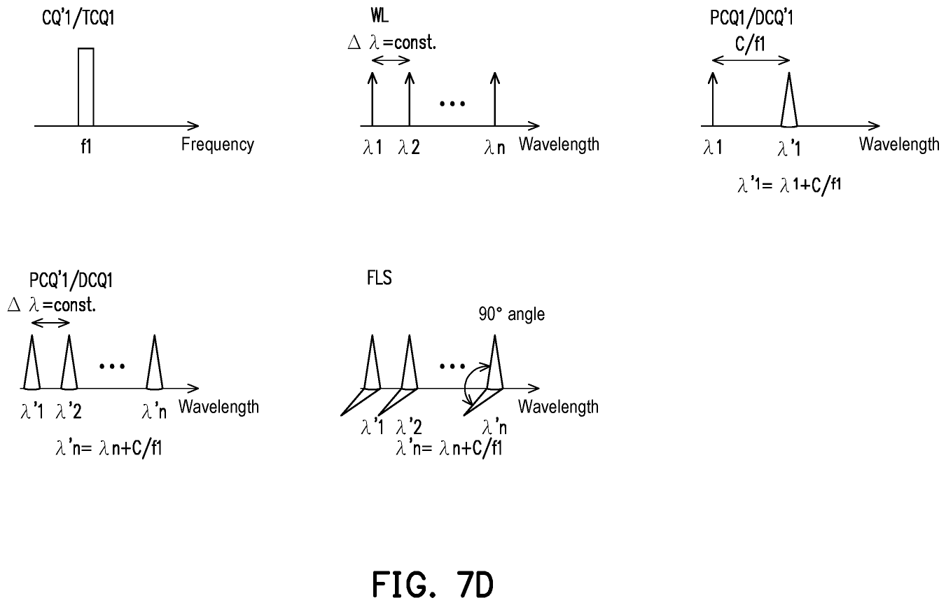

FIG. 7A to FIG. 7D are the circuit diagrams and corresponding signal schematic diagrams of a control signal transmission device 100-6 for a quantum computer according to the seventh embodiment of the disclosure. The control signal transmission device 100-6 in FIG. 7A integrates M times P (P is 2) control signals CQ11 to CQ2M into the optical signal FLS of the optical fiber 150 by using wavelength division multiplexing (WDM) technology combined with polarization multiplexing (Pol-Mux) technology, where M and P are both positive integers. As mentioned above, limited by the number of polarizations of light, P is set to 2 in this embodiment. Part of the circuit of the control signal transmission device 100-6 is similar to the aforementioned circuits of FIG. 3A and FIG. 4A, and some of the components herein use the same reference number.

The electro-optic modulation circuit 130-6 in FIG. 7A includes two sets of mixers (one set of mixers is formed of mixers 134-31 to 134-3M), an optical frequency comb generator 137, an optical splitter 135, two wavelength division modulation circuits WT1 and WT2, and a polarization beam combiner 136. Each set of mixers includes M mixers 134-31 to 134-3M. Each set of mixers receives corresponding M first control signals (e.g., the first control signals CQ11 to CQ1M), and increases the frequencies in the corresponding M first control signals to generate a set of upconverted signals CQ′1. The set of upconverted signals CQ′1 herein includes M upconverted signals, and the two sets of mixers generate two sets of upconverted signals CQ′1 and CQ′2.

The functions of the optical frequency comb generator 137, the optical splitter 135, and the polarization beam combiner 136 are similar to the functions of the corresponding components in FIG. 2A mentioned above. The two wavelength division modulation circuits WT1 and WT2 generate one of the two modulated optical signals with different wavelengths (herein, the modulated optical signal PCQ′1 is used as an example) according to different wavelengths and the corresponding set of upconverted signals CQ′1 and CQ′2. The two modulated optical signals have different polarization directions respectively. The polarization beam combiner 136 receives and integrates the modulated optical signal to generate the optical signal FLS.

The circuit structures of the wavelength division modulation circuits WT1 and WT2 are the same. As shown in FIG. 7B, the wavelength division modulation circuit WT1 includes a first wavelength demultiplexer 138, M electro-optic modulators 134-31 to 134-3M, and a wavelength beam combiner 139. The first wavelength demultiplexer 138 differentiates the multi-wavelength light into M specific wavelength lights according to the different wavelengths. The M electro-optic modulators 134-31 to 134-3M receive the corresponding set of upconverted signals from one of the aforementioned two sets of mixers, and integrate the corresponding set of upconverted signals into one of the M specific wavelength lights corresponding to different wavelengths to generate M wavelength divided optical signals (herein, the wavelength divided optical signal PCQ1 is taken as an example). The wavelength beam combiner 139 receives and integrates the M wavelength divided optical signals to generate one of the P modulated optical signals.

Returning to FIG. 7A, the optic-electro demodulation circuit 140-6 of FIG. 7A includes a polarization demultiplexer 144 and two wavelength division demodulation circuits WRP1 and WRP2. The polarization demultiplexer 144 converts the optical signal FLS into two differentiated optical signals DCQ1 and DCQ2 according to the aforementioned different polarization directions. The two wavelength division demodulation circuits WRP1 and WRP2 generate the second control signal according to the two differentiated optical signals DCQ1 and DCQ2.

The circuit structures of the wavelength division demodulation circuits WRP1 and WRP2 are the same. As shown in FIG. 7C, the wavelength division demodulation circuit WRP1 includes a second wavelength demultiplexer 145 and M photodetectors 142-31 to 142-3M. The second wavelength demultiplexer 145 differentiates one of the corresponding P differentiated optical signals into M differentiated optical signals DCQ′1 to DCQ′M according to the aforementioned different wavelengths. The M photodetectors 142-31 to 142-3M respectively generate M second control signals, such as second control signals TCQ1 to TCQM, according to the corresponding M differentiated optical signals DCQ′1 to DCQ′M, and respectively provide the second control signals TCQ1 to TCQM to the qubits QB1 to QBM.

FIG. 7D presents the modulation conditions of each signal in this embodiment with specific signals. One of the upconverted signals CQ′1 and one of the second control signals TCQ1 are electrical signals with frequency f1. Multi-wavelength light WL shown in FIG. 7D is an optical signal showing different waveforms at multiple different wavelengths λ1, λ2 . . . λn. The wavelength spacing Δλ between these wavelengths λ1, λ2 . . . λn is a constant. The wavelength divided optical signal PCQ1 and the differentiated optical signal DCQ′1 have a wavelength λ′1 and generate an optical signal with a corresponding waveform at the wavelength λ′1. The wavelength λ′1 is the value corresponding to the wavelength λ1 plus a distance (the value of light speed C divided by frequency f1). The modulated optical signal PCQ′1 and the differentiated optical signal DCQ1 are optical signals having multiple wavelengths λ′1, λ′2 . . . λ′n, and at these wavelengths λ′1, λ′2 . . . λ′n, optical signals corresponding to the waveforms are generated. These wavelengths λ′1, λ′2 . . . λ′n are the values corresponding to the wavelengths λ1, λ2 . . . λn plus a distance (the value of light speed C divided by frequency f1). The optical signal FLS is based on the aforementioned modulated optical signal PCQ′1 and further includes two waveforms of different polarities. The polarities between the two waveforms show a 90-degree angle difference.

It is known from FIG. 7A to FIG. 7D that the control signal transmission device 100-6 in FIG. 7A to FIG. 7C integrates a large number of control signals into the optical carrier by using the frequency division multiplexing (FDM) and polarization multiplexing (Pol-Mux) technologies, and thereby obtains control signals for controlling a large number of qubits in a cryogenic environment 105.

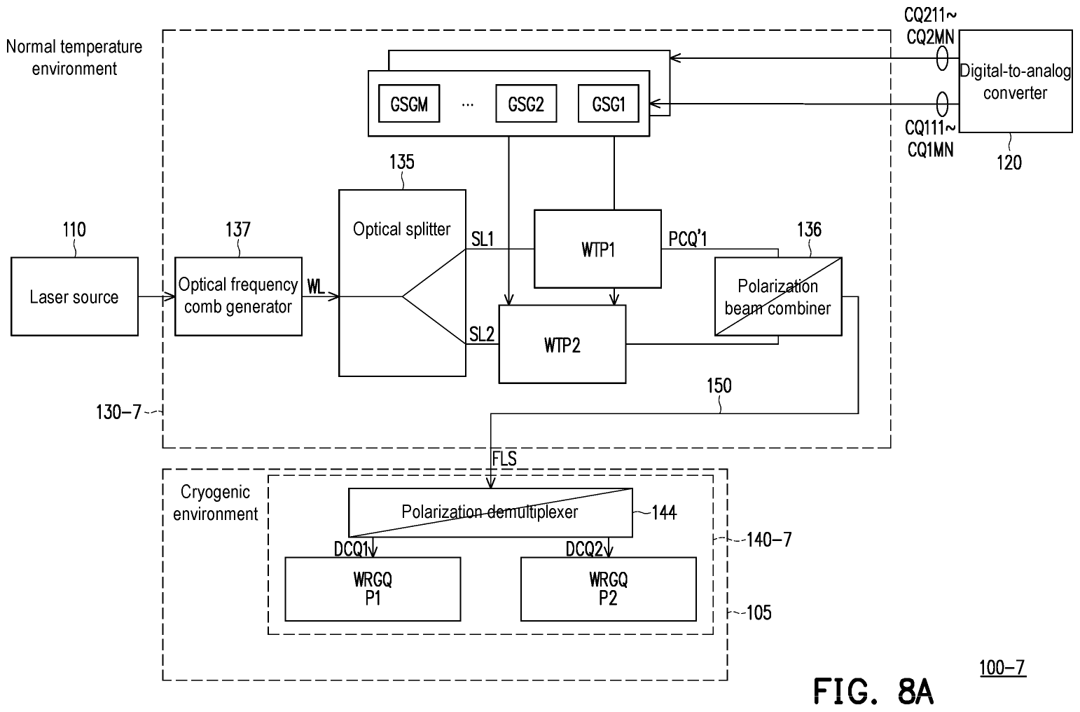

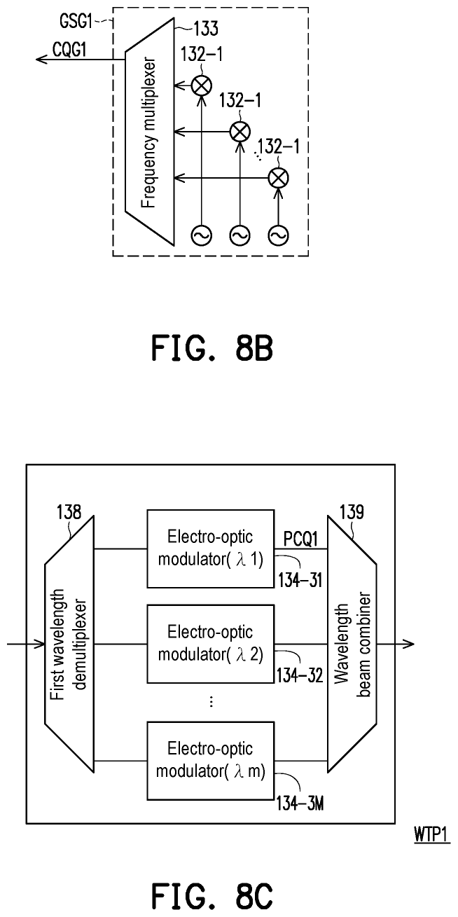

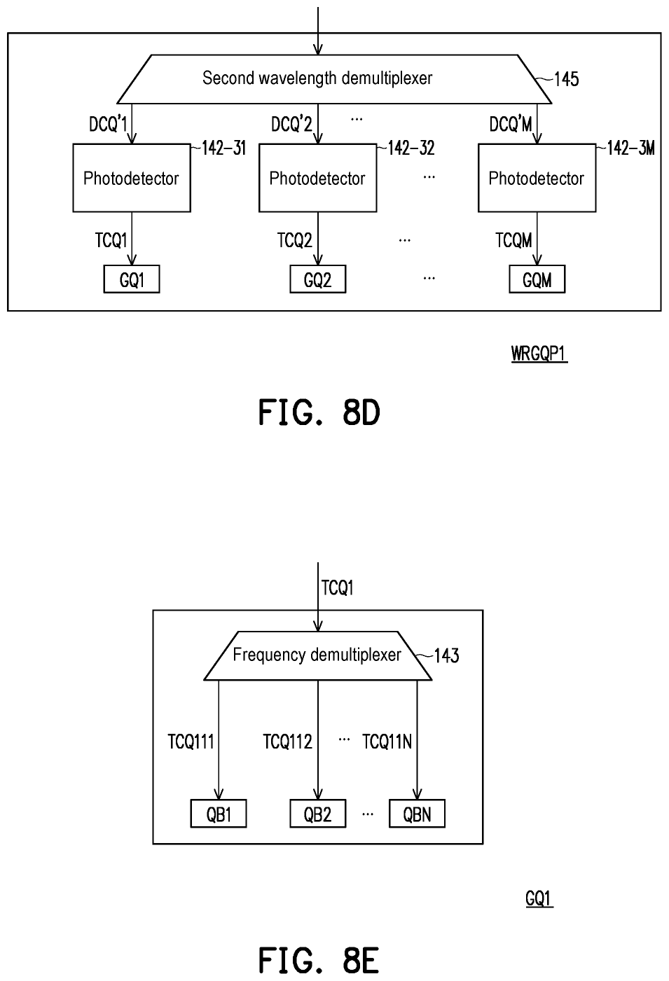

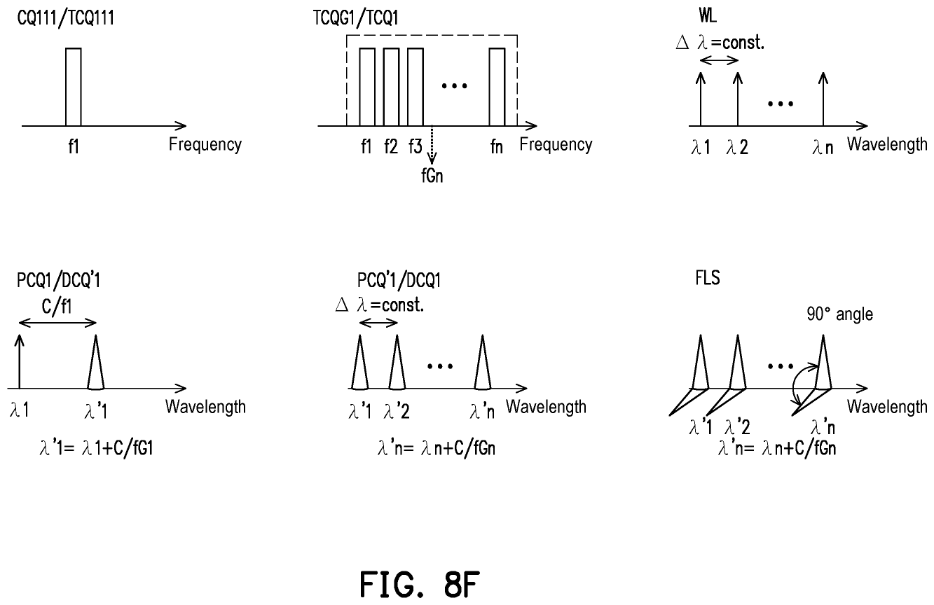

FIG. 8A to FIG. 8F are the circuit diagrams and corresponding signal schematic diagrams of a control signal transmission device 100-7 for a quantum computer according to the eighth embodiment of the disclosure. The control signal transmission device 100-7 in FIG. 8A integrates N times M times P (P is 2) control signals CQ111 to CQ1MN and CQ211 to CQ2MN into the optical signal FLS of the optical fiber 150 by using frequency division multiplexing (FDM) technology combined with wavelength division multiplexing (WDM) and polarization multiplexing (Pol-Mux) technology, where M, N, and P are all positive integers. As mentioned above, limited by the number of polarizations of light, P is set to 2 in this embodiment. Part of the circuit of the control signal transmission device 100-7 is similar to the circuit structure of the previous embodiments, and some components use the same reference number as in the previous embodiments.

The electro-optic modulation circuit 130-7 in FIG. 8A includes two sets of frequency division modulation circuits (herein, a set of frequency division modulation circuits GSG1 to GSGM are taken as an example), an optical frequency comb generator 137, an optical splitter 135, two wavelength division modulation circuits WTP1 and WTP2, and a polarization beam combiner 136. Each set of frequency division modulation circuits includes M frequency division modulation circuits GSG1 to GSGM. Each frequency division modulation circuit GSG1 to GSGM receives N first control signals to generate one of M frequency divided signals. The two sets of frequency division modulation circuit generates two sets of upconverted signals. Each frequency division modulation circuit WTP1 and WTP2 receives the corresponding set of upconverted signals and one of the two sub-lights SL1 and SL2, and generates one of two modulated optical signals with different wavelengths (herein, the modulated optical signal PCQ′1 is used as an example) according to different wavelengths and the corresponding set of upconverted signals. The two modulated optical signals have different polarization directions respectively. The polarization beam combiner 136 receives and integrates the modulated optical signal to generate the optical signal FLS.

The circuit structures of the frequency division modulation circuits GSG1 to GSGM are the same. Referring to FIG. 8B, the frequency division modulation circuit GSG1 includes N mixers 132-1 and the frequency multiplexer 133. The mixers 132-1 are coupled to the digital-to-analog converter 120 to receive corresponding first control signals and adjust the corresponding first control signals to different frequencies to generate N mixed signals. The frequency multiplexer 133 integrates the mixed signals into one of M frequency divided signals. Herein, the frequency divided signal CQG1 is taken as an example.

The circuit structures of the wavelength division modulation circuits WTP1 and WTP2 are the same. Referring to FIG. 8C, the wavelength division modulation circuit WTP1 includes a first wavelength demultiplexer 138, M electro-optic modulators 134-31 to 134-3M, and a wavelength beam combiner 139. The first wavelength demultiplexer 138 differentiates the multi-wavelength light into M specific wavelength lights according to the different wavelengths. The M electro-optic modulators 134-31 to 134-3M are respectively coupled to the first wavelength demultiplexer 138 and one of the corresponding two sets of frequency division modulation circuits, receive the corresponding set of upconverted signals from one of the aforementioned two sets of frequency division modulation circuits, and integrate the corresponding set of upconverted signals into one of the M specific wavelength lights corresponding to different wavelengths to generate M wavelength divided optical signals. Herein, the wavelength divided optical signal PCQ1 is taken as an example. The wavelength beam combiner 139 receives and integrates the M wavelength divided optical signals to generate one of the two modulated optical signals.

Returning to FIG. 8A, the optic-electro demodulation circuit 140-7 of FIG. 8A includes

a polarization demultiplexer 144 and two wavelength division and frequency division demodulation circuits WRGQP1 and WRGQP2. The polarization demultiplexer 144 converts the optical signal FLS into two differentiated optical signals DCQ1 and DCQ2 according to different polarization directions. The two wavelength division and frequency division demodulation circuits WRGQP1 and WRGQP2 generate second control signals according to the differentiated optical signals DCQ1 and DCQ2.

The circuit structures of the wavelength division and frequency division demodulation circuits WRGQP1 and WRGQP2 are the same. Specifically, referring to FIG. 8D, the wavelength division and frequency division demodulation circuit WRGQP1 includes a second wavelength demultiplexer 145, M photodetectors 142-31 to 142-3M, and M frequency demultiplexers located in circuits GQ1 to circuit GQM (shown in FIG. 8E). In FIG. 8D, the second wavelength demultiplexer 145 differentiates one of the corresponding two differentiated optical signals into M differentiated optical signals DCQ′1 to DCQ′M according to the aforementioned different wavelengths. The M photodetectors 142-31 to 142-3M respectively generate M electrical signals TCQ1 to TCQM according to the corresponding M differentiated optical signals DCQ′1 to DCQ′M.

The circuit structures of the circuit GQ1 to the circuit GQM are the same. In detail, referring to FIG. 8E, the circuit GQ1 includes a frequency demultiplexer 143. The frequency demultiplexer 143 splits one of the corresponding M electrical signals (e.g., the electrical signal TCQ1) into N second control signals according to different frequencies, such as the second control signals TCQ111 to TCQ11N in FIG. 8E.

FIG. 8F presents the modulation conditions of each signal in this embodiment with specific signals. The first control signal CQ111 and the second control signal TCQ111 are electrical signals with frequency f1. The electrical signal TCQ1 and the electrical signal TCQG1 are electrical signals that integrate multiple control signals with different frequencies f1 to fn, so their electrical signal waveforms have multiple frequencies f1 to fn. The average frequency of the electrical signal TCQ1 and the electrical signal TCQG1 is fGn. Multi-wavelength light WL shown in FIG. 8F is an optical signal showing different waveforms at multiple different wavelengths λ1, λ2 . . . λn. The wavelength spacing Δλ between these wavelengths λ1, λ2 . . . λn is a constant. The wavelength divided optical signal PCQ1 and the differentiated optical signal DCQ′1 have a wavelength λ′1, and generate an optical signal with a corresponding waveform at the wavelength λ′1. The wavelength λ′1 is the value of the wavelength λ1 plus a distance (the value of light speed C divided by frequency fG1). The modulated optical signal PCQ′1 and the differentiated optical signal DCQ1 have multiple wavelengths λ′1, λ′2 . . . λ′n, and at these wavelengths λ′1, λ′2 . . . λ′n, optical signals corresponding to the waveforms are generated. These wavelengths λ′1, λ′2 . . . λ′n are the values corresponding to the wavelengths λ1, λ2 . . . λn plus a distance (the value of light speed C divided by frequency fGn). The optical signal FLS is based on the aforementioned modulated optical signal PCQ′1 and further includes two waveforms of different polarities. The polarities between the two waveforms show a 90-degree angle difference.

It is known from FIG. 8A to FIG. 8F that the control signal transmission device 100-7 in FIG. 8A to FIG. 8E integrates a large number of control signals into the optical carrier by using the frequency division multiplexing (FDM), wavelength division multiplexing (WDM), and polarization multiplexing (Pol-Mux) technologies, and thereby obtains control signals for controlling a large number of qubits in a cryogenic environment 105.

To sum up, in the embodiment of the disclosure, the quantum computers and the control signal transmission technology integrate a large number of control signals into an optical carrier serving as a signal carrier by utilizing a variety of optical modulation techniques (e.g., frequency division multiplexing (FDM), wavelength division multiplexing (WDM), polarization multiplexing (Pol-Mux), and a combination of these multiplexing techniques), and use a single optical fiber as the transmission line. This achieves a quantum computer control architecture that transmits signals controlling a large number of qubits. The aforementioned architecture may reduce the introduction of heat energy into the extremely low temperature environment and facilitate the maintenance of heat insulation in the extremely low temperature environment.

What is claimed is:

1. A control signal transmission device for a quantum computer, comprising:
a laser source, providing a light;
a digital-to-analog converter, providing a plurality of first control signals;
an electro-optic modulation circuit, coupled to the digital-to-analog converter and the laser source, integrating the first control signals into the light to generate an optical signal;
an optical fiber, coupled to the electro-optic modulation circuit, wherein the electro-optic modulation circuit provides the optical signal to the optical fiber;
an optic-electro demodulation circuit, coupled to the optical fiber and configured to convert and split the optical signal into a plurality of second control signals; and
a plurality of qubits, coupled to the optic-electro demodulation circuit,
wherein the optic-electro demodulation circuit transmits the second control signals to the corresponding qubits, the qubits are controlled by the corresponding second control signals, an ambient temperature set by the optic-electro demodulation circuit and the qubits is lower than a preset temperature value.

2. The control signal transmission device according to claim 1, wherein the electro-optic modulation circuit comprises:
N mixers, coupled to the digital-to-analog converter to receive the corresponding first control signals, and adjusting the corresponding first control signals to different frequencies to generate N mixed signals, wherein N is a positive integer;
a frequency multiplexer, coupled to the N mixers, integrating the mixed signals into an integrated signal; and
an electro-optic modulator, coupled to the frequency multiplexer and the laser source, integrating the integrated signal into the light provided by the laser source to generate the optical signal.

3. The control signal transmission device according to claim 2, wherein the optic-electro demodulation circuit comprises:
a photodetector, coupled to the optical fiber and converting the optical signal into an electrical signal; and
a frequency demultiplexer, coupled to the photodetector, splitting the electrical signal into the second control signals according to the different frequencies, wherein a number of the second control signals is N.

4. The control signal transmission device according to claim 1, wherein the electro-optic modulation circuit comprises:
P mixers, coupled to the digital-to-analog converter to receive the corresponding first control signals, and increasing frequencies of the corresponding first control signals to generate P upconverted signals, wherein P is a positive integer;
an optical splitter, coupled to the laser source, splitting the light into P sub-lights;
P electro-optic modulators, coupled to the optical splitter and the mixers, receiving the corresponding upconverted signals from the corresponding mixers, and integrating the corresponding upconverted signals into the sub-lights to generate P modulated optical signals having different polarization directions; and
a polarization beam combiner, coupled to the electro-optic modulators, receiving and integrating the modulated optical signal to generate the optical signal.

5. The control signal transmission device according to claim 4, wherein the optic-electro demodulation circuit comprises:
a polarization demultiplexer, coupled to the optical fiber, converting the optical signal into P differentiated optical signals according to the different polarization directions; and
P photodetectors, coupled to the polarization demultiplexer, respectively generating the second control signals according to the corresponding differentiated optical signals, wherein a number of the second control signals is P.

6. The control signal transmission device according to claim 1, wherein the electro-optic modulation circuit comprises:
M mixers, coupled to the digital-to-analog converter to receive the corresponding first control signals, and increasing frequencies of the corresponding first control signals to generate M upconverted signals, wherein M is a positive integer;
an optical frequency comb generator, coupled to the laser source, generating a multi-wavelength light from the light according to different wavelengths;
a first wavelength demultiplexer, coupled to the optical frequency comb generator, differentiating the multi-wavelength light into M specific wavelength lights according to the different wavelengths;
M electro-optic modulators, coupled to the first wavelength demultiplexer and the mixers, receiving the corresponding upconverted signals from the mixers, and integrating the corresponding upconverted signals into the specific wavelength lights corresponding to the different wavelengths to generate M first wavelength divided optical signals; and
a wavelength beam combiner, coupled to the electro-optic modulators, receiving and integrating the first wavelength divided optical signals to generate the optical signal.

7. The control signal transmission device according to claim 4, wherein the optic-electro demodulation circuit comprises:
a second wavelength demultiplexer, coupled to the optical fiber, converting the optical signal into M second wavelength divided optical signals according to different wavelengths; and
M photodetectors, coupled to the second wavelength demultiplexer, generating the second control signals according to the second wavelength divided optical signals, wherein a number of the second control signals is M.

8. The control signal transmission device according to claim 1, wherein a number of the first control signals is N times P, and N and P are positive integers,
the electro-optic modulation circuit comprising:
P frequency division modulation circuits, each of the frequency division modulation circuits receiving N first control signals to generate one of P frequency divided signals;
an optical splitter, coupled to the laser source, dividing the light into P sub-lights;
P electro-optic modulators, coupled to the optical splitter and the frequency division modulation circuits, receiving the corresponding frequency divided signals from the corresponding frequency division modulation circuits, and integrating the corresponding frequency divided signals into the sub-lights to generate P modulated optical signals having different polarization directions; and
a polarization beam combiner, coupled to the electro-optic modulator, receiving and integrating the modulated optical signals to generate the optical signal,
wherein each of the frequency division modulation circuits comprises:
N mixers, coupled to the digital-to-analog converter to receive the corresponding first control signals, and adjusting the corresponding first control signals to different frequencies to generate N mixed signals, wherein N is a positive integer; and
a frequency multiplexer, coupled to the N mixers and integrating the mixed signals into one of the P frequency divided signals.

9. The control signal transmission device according to claim 8, wherein the optic-electro demodulation circuit comprises:
a polarization demultiplexer, coupled to the optical fiber, converting the optical signal into P differentiated optical signals according to the different polarization directions;
P photodetectors, coupled to the polarization demultiplexer, respectively generating P electrical signals according to the corresponding differentiated optical signals; and
P frequency demultiplexers, respectively coupled to the corresponding photodetectors, splitting one of the corresponding P electrical signals into N of the second control signals according to the different frequencies.

10. The control signal transmission device according to claim 1, wherein a number of the first control signals is N times M, and N and M are positive integers,
the electro-optic modulation circuit comprising:
M frequency division modulation circuits, each of the frequency division modulation circuits receiving N of the first control signals to generate one of M frequency divided signals;
an optical frequency comb generator, coupled to the laser source, generating a multi-wavelength light from the light according to different wavelengths;
a first wavelength demultiplexer, coupled to the optical frequency comb generator, differentiating the multi-wavelength light into M specific wavelength lights according to the different wavelengths;
M electro-optic modulators, coupled to the first wavelength demultiplexer and the frequency division modulation circuits, receiving the corresponding frequency divided signals from the frequency division modulation circuit, and integrating the corresponding frequency divided signals into the M specific wavelength lights corresponding to the different wavelengths to generate M first wavelength divided optical signals; and
a wavelength beam combiner, coupled to the electro-optic modulators, receiving and integrating the first wavelength divided optical signals to generate the optical signal,
wherein each of the frequency division modulation circuits comprises:
N mixers, coupled to the digital-to-analog converter to receive the corresponding first control signals, and adjusting the corresponding first control signals to different frequencies to generate N mixed signals, wherein N is a positive integer; and
a frequency multiplexer, coupled to the N mixers and integrating the mixed signals into one of the M frequency divided signals.

11. The control signal transmission device according to claim 10, wherein the optic-electro demodulation circuit comprises:
a second wavelength demultiplexer, coupled to the optical fiber, converting the optical signal into M second differentiated optical signals according to different wavelengths; and
M photodetectors, coupled to the second wavelength demultiplexer, respectively generating M electrical signals according to the corresponding second differentiated optical signals; and
M frequency demultiplexers, respectively coupled to the corresponding photodetectors, wherein each of the frequency demultiplexers splits one of the corresponding M electrical signals into N of the second control signals.

12. The control signal transmission device according to claim 1, wherein a number of the first control signals is M times P, and M and P are positive integers,
the electro-optic modulation circuit comprising:
P sets of mixers, coupled to the digital-to-analog converter, each set of mixers comprising M mixers, each set of mixers receiving corresponding M first control signals and increasing frequency of the corresponding M first control signals to generate a set of upconverted signals, the set of upconverted signals comprising M upconverted signals, and the P set of mixers generating P sets of upconverted signals;
an optical frequency comb generator, coupled to the laser source, generating a multi-wavelength light from the light according to different wavelengths;
an optical splitter, coupled to the optical frequency comb generator, splitting the multi-wavelength light into P sub-lights;
P wavelength division modulation circuits, coupled to the optical splitter, each frequency division modulation circuit receiving the corresponding set of upconverted signals and one of the P sub-lights, and generating one of P modulated optical signals having the different wavelengths according to the different wavelengths and the corresponding set of upconverted signals,
wherein the P modulated optical signals respectively have different polarization directions; and
a polarization beam combiner, coupled to the P wavelength division modulation circuits, receiving and integrating the modulated optical signals to generate the optical signal,
wherein each of the wavelength division modulation circuits comprises:
a first wavelength demultiplexer, coupled to the optical splitter, differentiating the multi-wavelength light into M specific wavelength lights according to the different wavelengths;
M electro-optic modulators, coupled to the first wavelength demultiplexer and one of the corresponding P sets of mixers, receiving the corresponding set of upconverted signals from one of the P sets of mixers, integrating the corresponding set of upconverted signals into one of the M specific wavelength lights corresponding to the different wavelengths to generate M wavelength divided optical signals; and
a wavelength beam combiner, coupled to the M electro-optic modulators, receiving and integrating the M wavelength divided optical signals to generate one of the P modulated optical signals.

13. The control signal transmission device according to claim 12, wherein the optic-electro demodulation circuit comprises:
a polarization demultiplexer, coupled to the optical fiber, converting the optical signal into P differentiated optical signals according to the different polarization directions; and
P wavelength division demodulation circuits, coupled to the polarization demultiplexer, generating the second control signals according to the P differentiated optical signals,
wherein each of the wavelength division demodulation circuits comprises:
a second wavelength demultiplexer, coupled to the polarization demultiplexer, differentiating one of the corresponding P differentiated optical signals into M differentiated optical signals according to the different wavelengths; and
M photodetectors, coupled to the second wavelength demultiplexer, respectively generating M of the second control signals according to the corresponding M differentiated optical signals.

14. The control signal transmission device according to claim 1, wherein a number of the first control signals is N times M times P, and N, M and P are positive integers,
the electro-optic modulation circuit comprising:
P sets of frequency division modulation circuits, coupled to the digital-to-analog converter, each set of frequency division modulation circuits comprising M frequency division modulation circuits, each of frequency division modulation circuit receiving N of the first control signals to generate one of M frequency divided signals, the P sets of frequency division modulation circuits generating P sets of upconverted signals;
an optical frequency comb generator, coupled to the laser source, generating a multi-wavelength light from the light according to different wavelengths;
an optical splitter, coupled to the optical frequency comb generator, splitting the multi-wavelength light into P sub-lights;
P wavelength division modulation circuits, coupled to the optical splitter, each frequency division modulation circuit receiving the corresponding set of upconverted signals and one of the P sub-lights, and generating one of P modulated optical signals having the different wavelengths according to the different wavelengths and the corresponding set of upconverted signals,
wherein the P modulated optical signals respectively have different polarization directions; and
a polarization beam combiner, coupled to the P wavelength division modulation circuits, receiving and integrating the modulated optical signals to generate the optical signal,
wherein each of the frequency division modulation circuits comprises:
N mixers, coupled to the digital-to-analog converter to receive the corresponding first control signals, and adjusting the corresponding first control signals to different frequencies to generate N mixed signals, wherein N is a positive integer; and
a frequency multiplexer, coupled to the N mixers and integrating the mixed signals into one of the M frequency divided signals,
wherein each of the wavelength division modulation circuits comprises:
a first wavelength demultiplexer, coupled to the optical splitter, differentiating the multi-wavelength light into M specific wavelength lights according to the different wavelengths;
M electro-optic modulators, coupled to the first wavelength demultiplexer and one of the corresponding P sets of frequency division modulation circuits, receiving the corresponding set of upconverted signals from one of the P sets of frequency division modulation circuits, integrating the corresponding set of upconverted signals into one of the M specific wavelength lights corresponding to the different wavelengths to generate M wavelength divided optical signals; and
a wavelength beam combiner, coupled to the M electro-optic modulators, receiving and integrating the M wavelength divided optical signals to generate one of the P modulated optical signals.

15. The control signal transmission device according to claim 14, wherein the optic-electro demodulation circuit comprises:
a polarization demultiplexer, coupled to the optical fiber, converting the optical signal into P differentiated optical signals according to the different polarization directions;
P wavelength division and frequency division demodulation circuits, coupled to the polarization demultiplexer, generating the second control signals according to the P differentiated optical signals,
wherein each of the wavelength division and frequency division demodulation circuits comprises:
a second wavelength demultiplexer, coupled to the polarization demultiplexer, differentiating one of the corresponding P differentiated optical signals into M differentiated optical signals according to the different wavelengths;
M photodetectors, coupled to the second wavelength demultiplexer, respectively generating M electrical signals according to the corresponding M differentiated optical signals; and
M frequency demultiplexers, respectively coupled to the corresponding photodetectors, wherein each of the frequency demultiplexers splits one of the corresponding M electrical signals into N of the second control signals.
